(19) United States
(12) Patent Application Publication
(10) Pub. No.: US 2010/0183399 A1
(43) Pub. Date: Jul. 22, 2010

(54) ANTI-LOOSENING FASTENER

(76) Inventor: Yukio Suga, Kure-City (JP)

Correspondence Address: Cislo & Thomas LLP, 1333 2nd Street, Suite #500, Santa Monica, CA, 90401-4110, US

(21) Appl. No.: 12/640,502

(22) Filed: Dec. 17, 2009

(30) Foreign Application Priority Data
Jan. 20, 2009 (JP) 2009-000216

(51) Int. Cl. F16B 39/00

(52) U.S. Cl. 411/259

(57) ABSTRACT

To provide a fastener that is able to prevent the tightening nut from loosening over an extended period. The anti-loosening fastener comprises a bolt that has a head and a shank, where the shank comprises a root-side of a large diameter and an end-side of a small diameter, the root-side has a tightening thread formed on it in one turning direction, the end-side has an anti-loosening thread formed on it in the other turning direction, and the minor diameter of the tightening thread is greater than the major diameter of the anti-loosening thread; a tightening nut is screwed on the tightening thread; and an anti-loosening nut is screwed on the anti-loosening thread with the front end in contact with the rear end of the tightening nut and may have the same outer dimensions as the tightening nut.

### CROSS-REFERENCE TO RELATED APPLICATIONS

This document is a U.S. Utility Patent Application which is related to, and claims the priority through earlier-filed Japanese Utility Model Application No. 2009-000216 (Registration No. 3149555), filed on Jan. 20, 2009, all the subject matter of which is herein incorporated by this reference in its entirety for all purposes.

### TECHNICAL FIELD OF THE INVENTION

This invention relates to a fastener that consists of bolts and nuts, is intended for fastening multiple objects together, and has an anti-loosening feature.

### BACKGROUND OF THE INVENTION

Bolts and nuts have been used to fasten multiple objects together. A bolt is put through a hole in the object(s) to be fastened, and a nut is screwed on the threaded part of the bolt to tighten them.

To prevent nuts from loosening, so-called double-nut fasteners are widely used. Such a fastener has an anti-loosening nut in addition to the tightening nut. The double-nut fastener prevents the tightened nut from loosening, though not completely.

Though the conventional double-nut fastener works to prevent the tightened nut from loosening, the effect is not always sufficient. Particularly, when the fastened objects vibrate, the conventional double-nut fasteners tend to loosen in a short period.

This invention addresses the above problem, intending to provide a fastener that is capable of preventing the tightened nut from loosening for an extended period.

### SUMMARY OF THE INVENTION

Refer to FIGS. 1 through 6. The anti-loosening fastener shown in FIGS. 1-3 may comprise a bolt 10, a tightening nut 20, and an anti-loosening nut 30. The bolt 10 may have a head 11 and an shank 12, and the shank 12 may have a two-step construction consisting of a root-side of a large diameter and an end-side of a small diameter. The shank's root-side may have a tightening thread 13 formed on it in one turning direction, and the shank's end-side may have an anti-loosening thread 14 formed on it in the other turning direction. As shown in FIG. 6, the minor diameter D of the tightening thread 13 may be greater than the major diameter d of the anti-loosening thread 14. As shown in FIGS. 5-6, the tightening nut 20 is screwed on the tightening thread 13. The anti-loosening nut 30 may have the same outer dimensions as the tightening nut 20 and may have screwed on the anti-loosening thread 14 with its front end in contact with the rear end of the tightening nut 13.

The anti-loosening fastener may also comprise a bolt 10, a tightening nut 20, and an anti-loosening nut 30. The bolt 10 may have a head 11 and a shank 12, and the shank 12 may have a two-step construction consisting of a root-side of a large diameter and an end-side of a small diameter. The root-side may have a tightening thread 13 formed on it in one turning direction, and the end-side may have an anti-loosening thread 14 formed on it in the other turning direction. The minor diameter D of the tightening thread 13 may be greater than the major diameter d of the anti-loosening thread 14. The tightening nut 20 is screwed on the tightening thread 13. The anti-loosening nut 30 may have the same outer dimensions as the tightening nut 20 and may be screwed on the anti-loosening thread 14 with its front end in contact with the rear end of the tightening nut 13. In addition, on the boundary between the tightening thread 13 and the anti-loosening thread 14, there may be a circular groove 15 on which the rear end of the tightening nut 20 is positioned.

The anti-loosening fastener may have a right-handed tightening thread 13 and a left-handed anti-loosening thread 14. Alternatively, the thread directions may be reversed.

The anti-loosening fastener may also have the lead Y of the tightening thread 13 equal to the lead Z of the anti-loosening thread 14.

The anti-loosening fastener prevents the tightening nut 20 from loosening because the two threads are formed in opposite circumferential directions: the tightening thread 13 is formed in the one direction on the root-side of the bolt 10; and the anti-loosening thread 14 is formed in the other direction on the end-side.

Specifically, while the objects 50 are fastened and vibration is applied to the anti-loosening fastener 1, the rotating force works on the two nuts (the tightening nut 20 screwed on the tightening thread 13 and the anti-loosening nut 30 screwed on the anti-loosening thread 14) in opposite axial directions because the threads are formed in opposite radial directions. For instance, when a force works to turn the tightening nut 20 counterclockwise (in the loosening direction), the same force also works to turn the anti-loosening nut 30 counterclockwise (in the tightening direction). Therefore, the front end of the anti-loosening nut 30 is strongly pressed against the rear end of the tightening nut 20, preventing the tightening nut 20 from turning counterclockwise and thus preventing the tightening nut 20 from loosening.

As the minor diameter D of the tightening thread 13 may be greater than the major diameter d of the anti-loosening thread 14, the tightening nut 20 may easily pass the anti-loosening thread 14 and reach the tightening thread 13. This feature may make it easy to screw the tightening nut 20.

As the tightening nut 20 and the anti-loosening nut 30 may have the same outer dimensions, the two types of nut can be tightened with the same tool (such as a spanner). This feature provides excellent operability.

An anti-loosening fastener with a circular groove 15 may have its own advantage. The circular groove 15 may be formed on the boundary between the tightening thread 13 and the anti-loosening thread 14 so that the rear end of the tightening nut 20 may be positioned there. Thus, for instance, even if the height H of the tightening nut 20 is shorter than the specification due to production variances, the anti-loosening nut 30 may be screwed on the anti-loosening thread 14 with its front end pressed against the rear end of the tightening nut 20. This feature securely prevents the tightening nut 20 from loosening.

Additionally, the circular groove 15 and the resulting space between the tightening thread 13 and the anti-loosening thread 14 may make it easier to form these separate threads.

The anti-loosening fastener may have the tightening thread 13 right-handed and the anti-loosening thread 14 left-handed (in other words, the tightening nut 20 is right-handed and the anti-loosening nut 30 is left-handed). Such a configuration may allow turning the tightening nut 20 in the same radial direction as an ordinary nut (clockwise). The anti-loosening nut 30 may be screwed in the opposite circumferential direction (counterclockwise).

The anti-loosening fastener may have the lead Y of the tightening thread 13 made equal to the lead Z of the anti-loosening thread 14 so that both nuts 20 and 30 move the same distance per turn. This feature may lessen the strangeness the operator may feel when turning the nuts. With different leads, the operator turning the nuts may feel like something is wrong from the feeling transmitted via the spanner to the hand or from the look of the nuts' movements.

### BRIEF DESCRIPTION OF THE DRAWINGS

FIG. 1 is a side view of the bolt in an embodiment of an anti-loosening fastener.

FIG. 2a is a front view of an embodiment of an anti-loosening nut.

FIG. 2b is a side view of an embodiment of an anti-loosening nut.

FIG. 3a is a front view of an embodiment of a tightening nut.

FIG. 3b is a side view of an embodiment of a tightening nut.

FIG. 4a is a front view of an embodiment of a washer.

FIG. 4b is a side view of an embodiment of a washer.

FIG. 5 is a cross-section side view of an embodiment of an anti-loosening fastener.

FIG. 6 is an enlarged cross section of the major part of the bolt in an embodiment of an anti-loosening fastener.

FIG. 7 is a cross section of an assembly indicating the conditions of the test of the anti-loosening function.

### DESCRIPTION OF THE PREFERRED EMBODIMENTS

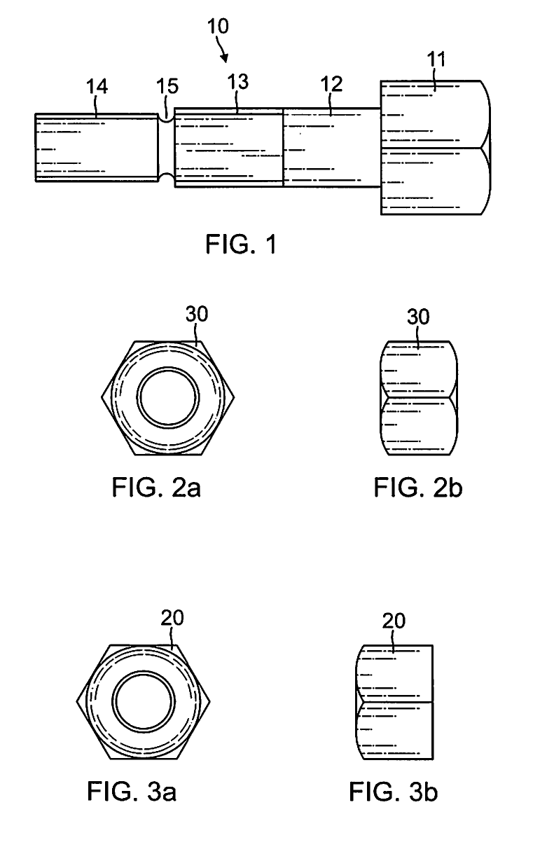

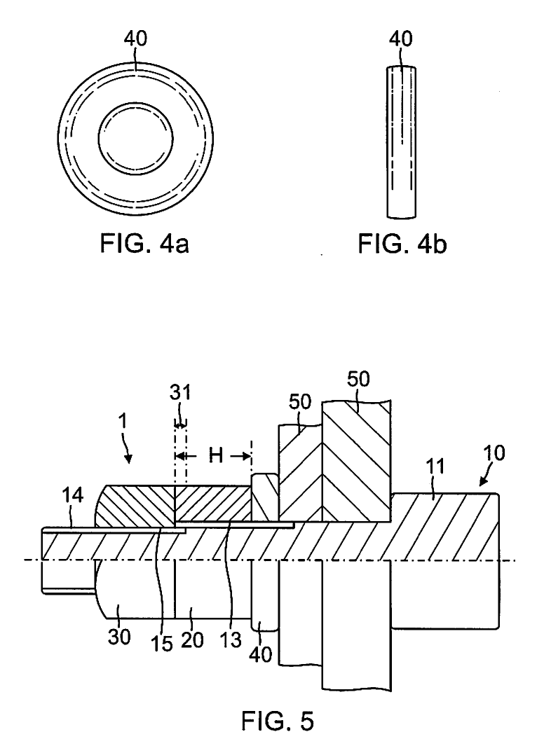

FIGS. 1 through 6 depict certain embodiments of the anti-loosening fastener. The anti-loosening fastener consists of a bolt 10, a tightening nut 20, and an anti-loosening nut 30. The bolt 10 may have a head 11 and a shank 12, and the shank 12 may have a two-step construction consisting of a root-side of a large diameter and an end-side of a small diameter. The shank's root-side may have a thread formed in one direction (clockwise), which may be the right-handed tightening thread 13. Although a typical bolt has a head, the bolt 10 may not require a head in certain applications, such as if it is welded to a larger structure, or has some other structure on the “head” end that affixes it to a large structure, or some other configuration that eliminates the need for a head. The “shank” 12 is the entire length of the bolt below the “head” 11, or as just discussed, whatever may substitute for the head.

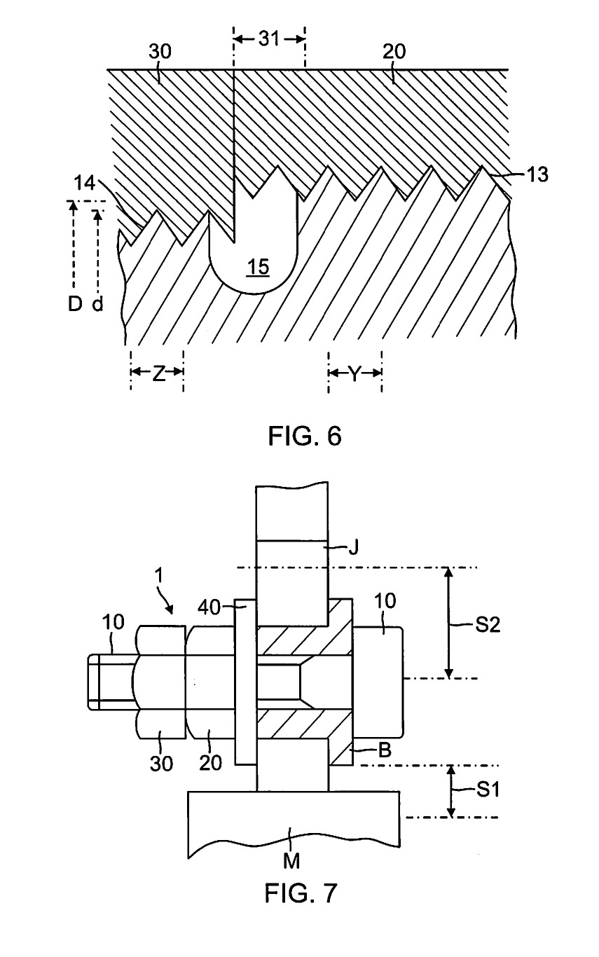

The shank's end-side may have a thread formed in the other direction (counterclockwise), which may be the left-handed anti-loosening thread. The minor diameter D of the tightening thread 13 may be greater than the major diameter d of the anti-loosening thread 14 (see FIG. 6). The major diameter d is the “peak” of the thread, whereas the minor diameter D is the “valley” of the thread.

The tightening nut 20 may be screwed onto the tightening thread 13, and, in this embodiment, it is right-handed and matches the tightening thread 13. The anti-loosening nut 30 is left-handed so that it can be screwed onto the anti-loosening thread 14. The tightening nut 20 and the anti-loosening nut 30 may be hexagonal and may have the same outer dimensions. Such identical outer dimensions may be as to the shape of the nuts, the height of the nuts, or both. Alternatively, the shape and/or heights could be different. The tightening nut 20 may be left-handed and the anti-loosening nut 30 right-handed, and the nuts 20 and 30 may be non-hexagonal (square, for instance).

In one embodiment, there may be a circular groove 15 on the boundary between the tightening thread 13 and the anti-loosening thread 14 where the rear end of the tightening nut 20 is positioned. For this reason, there is a play in the thread 31 in the rear end of the tightening nut 20 where the thread of the tightening nut 20 is not screwed onto the tightening thread 13. The play in the thread 31 allows the tightening nut 20 and the anti-loosening nut 30 to come in contact with each other smoothly. The outer diameter of the circular groove 15 may be the same as or smaller than the minor diameter D of the anti-loosening thread 14. In addition, this embodiment may have a washer 40 between the tightening nut 20 and the fastened object.

The anti-loosening fastener in one embodiment has a right-handed tightening thread 13 on the shank's root-side of the bolt 10 and has a left-handed anti-loosening thread 14 on the shank's end-side. When vibration is applied to the anti-loosening fastener, the rotating force works on the tightening thread 13 and the anti-loosening thread 14 in opposite axial directions because the threads are formed in opposite circumferential directions. Therefore, the front end of the anti-loosening nut 30 is securely pressed against the rear end of the tightening nut 20, thus preventing the tightening nut 20 from loosening.

If the minor diameter D of the tightening thread 13 is greater than the major diameter d of the anti-loosening thread 14, the tightening nut 20 may easily pass the anti-loosening thread 14 to reach the tightening thread 13. Such a feature may make it easy to screw the tightening nut 20.

In an embodiment where the tightening nut 20 and the anti-loosening nut 30 have the same outer dimensions, the two types of nut may be tightened with the same spanner or the like. Such a configuration provides excellent operability.

In an embodiment with a circular groove 15, the groove may be formed on the boundary between the tightening thread 13 and the anti-loosening thread 14 so that the rear end of the tightening nut 20 is positioned there. Thus, for instance, even if the height H of the tightening nut 20 is shorter than the specification due to production dispersion, the rear end of the anti-loosening nut 30 may be securely pressed against the front end of the tightening nut 20.

The anti-loosening fastener in one embodiment may have a washer 40, either locking or non-locking, but the washer 40 may be excluded. In that case, the lengths (heights) of the tightening thread 13 and the tightening nut 29 are determined so as to position the rear end of the tightening nut 20 on the circular groove 15.

Implementation

To confirm the anti-loosening function of the anti-loosening fastener, the inventors conducted a comparison test against the conventional, so-called double-nut fastener. The evaluation was based on a vibration impact loosening test designed in reference to the NAS standards (United States National Aerospace Standards). Due to the limited tester capability, the vibration stroke was 9 mm instead of the 11 mm defined in the NAS standards.

The test conditions, procedure, results and evaluation are as described below. FIG. 7 shows the configuration in which the test was conducted.

Test Conditions
Tester: Vibration tester (G-0110, Shinken Corporation)
Test jig: Based on NAS standards
Vibration frequency: 30 Hz (1800 rpm)
Vibration stroke (S1): 9 mm (Perpendicular, set manually)
Impact stroke (S2): 11 mm
Test time: 19 minutes 22 seconds (stopped upon loosening)
Judgment of looseness: The set marks of the bolt and nut are misaligned with each other and the bolt and nut can be turned by the hand.

Test Procedure
1. The fastener parts (bolt and nuts) were degreased with a petroleum solvent.
2. Machine oil was applied to the bolt threads.
3. The fastener was attached to the jig (J) equipped with a vibration barrel (B), and the bolt was tightened with a torque wrench.
   (The tightening direction and torque were as shown in the results below.)
4. The jig (J) was installed on the vibration base (M) of the tester.
5. With the test time set to 20 minutes, vibration was started. The amplitude was gradually increased from 0 mm, and the test started after 38 seconds when the amplitude reached 9 mm.

Test Results
1. Anti-loosening fastener of the invention
Tightening procedure
(1) The tightening nut (20) was tightened at 100 kN/m.
(2) The anti-loosening nut (30) was tightened at 70 kN/m.
Table 1 shows the test results.

TABLE 1

| Test count | Test results |
|---|---|
| 1 | Not loosened. |
| 2 | Not loosened. |
| 3 | Not loosened. |

2. Conventional fastener (double nuts)
Tightening procedure
(1) The lower nut (equivalent to the tightening nut (20) of the invention) was tightened at 75 kN/m.
(2) The upper nut (equivalent to the anti-loosening nut (30) of the invention) was tightened at 100 kN/m.
(3) After the upper nut was tightened and fastened, the lower nut was tightened in reverse direction at 100 kN/m so that it was securely fastened to the upper nut.
Table 2 shows the test results.

TABLE 2

| Test count | Test results |
|---|---|
| 1 | Loosened in 11 minutes. |
| 2 | Not loosened. |
| 3 | Loosened in 5 minutes. |

Evaluation
As shown in the above test results, the anti-loosening fastener of the invention prevented the tightening nut (20) and the anti-loosening nut (30) from loosening in all of the three tests while the conventional fastener loosened in two tests out of three.
Likewise, it has been confirmed that the anti-loosening function of the anti-loosening fastener of the invention is far superior to the conventional double-nut fastener.

### EXPLANATION OF SYMBOLS

1 Anti-loosening fastener

10 Bolt

11 Head

12 Shank

13 Tightening thread

14 Anti-loosening thread

15 Circular groove

20 Tightening nut

30 Anti-loosening nut

31 Play in thread

40 Washer

50 Tightened object

B Vibration barrel

D Minor diameter of the tightening thread

d Major diameter of the tightening thread

H Height of the tightening nut

J Jig

M Vibration base

Y Tightening thread lead

Z Anti-loosening thread lead

S1 Vibration stroke

S2 Impact stroke

1. An anti-loosening fastener, comprising:
a bolt having a shank;
the shank comprising a root-side portion having a first diameter, and an end-side portion having a second diameter, the second diameter being smaller than the first diameter;
a tightening thread on the root-side portion threaded in a first direction, the tightening thread having a first major and first minor diameter and a first lead;
an anti-loosening thread on the end-side portion threaded in a second direction, opposite the first direction, the anti-loosening thread having a second major and second minor diameter and a second lead, wherein the first minor diameter of the tightening thread is greater than the second major diameter of the anti-loosening thread, and wherein the first lead is equal to the second lead;
a circular groove between the tightening thread and the anti-loosening thread;
a tightening nut fastenable to the tightening thread, the tightening nut having a first outer dimension; and
an anti-loosening nut fastenable to the anti-loosening thread, the anti-loosening nut having a second outer dimension, wherein the first and second outer dimensions are the same.

2. An anti-loosening fastener comprising:
a bolt having a shank, the shank comprising a root-side portion of a first diameter, and an end-side portion of a second diameter, the second diameter being smaller than the first diameter;
a tightening thread on the root-side portion threaded in a first direction, the tightening thread having a first major and first minor diameter;
an anti-loosening thread on the end-side portion threaded in a second direction, opposite the first direction, the anti-loosening thread having a second major and second minor diameter, wherein the first minor diameter of the tightening thread is greater than the second major diameter of the anti-loosening thread;
a tightening nut fastenable to the tightening thread; and
an anti-loosening nut fastenable to the anti-loosening thread.

3. The anti-loosening fastener of claim 2, further comprising a circular groove between the tightening thread and the anti-loosening thread.

4. The anti-loosening fastener of claim 2, wherein the anti-loosening nut has a first outer dimension, the tightening nut has a second outer dimension, wherein the first and second outer dimensions are the same.

5. The anti-loosening fastener of claim 3, wherein the anti-loosening nut has a first outer dimension, the tightening nut has a second outer dimension, wherein the first and second outer dimensions are the same.

6. The anti-loosening fastener of claim 2, wherein the shank's root-side portion has a first lead, and the shank's end-side portion has a second lead, and the first lead and second lead are equal.

7. The anti-loosening fastener of claim 3, wherein the shank's root-side portion has a first lead, and the shank's end-side portion has a second lead, and the first lead and second lead are equal.

8. The anti-loosening fastener of claim 4, wherein the shank's root-side portion has a first lead, and the shank's end-side portion has a second lead, and the first lead and second lead are equal.

9. The anti-loosening fastener of claim 5, wherein the shank's root-side portion has a first lead, and the shank's end-side portion has a second lead, and the first lead and second lead are equal.

10. A method of using an anti-loosening fastener, comprising the steps of:
having a bolt with a shank with a root-side and an end-side, the shank's root side having a tightening thread that is threaded in one turning direction, the tightening thread having a first major diameter and a first minor diameter, and the shank's end-side having an anti-loosening thread that is threaded in an opposite turning direction, the anti-loosening thread having a second major diameter and a second minor diameter, wherein the first minor diameter is greater than the second major diameter,
turning a tightening nut on the tightening thread against an object to be secured; and
turning an anti-loosening nut on the anti-loosening thread so a front end of the anti-loosening nut contacts a rear end of the tightening nut.
